(19) United States
(12) Patent Application Publication
(10) Pub. No.: US 2026/0319066 A1
(43) Pub. Date: Oct. 15, 2026

(54) METHOD OF CORRECTING ALIGNMENT STATUS OF RADAR AND ELECTRONIC APPARATUS THEREFOR

(71) Applicant: AGENCY FOR DEFENSE DEVELOPMENT, Daejeon (KR)

(72) Inventors: Ji Hoon KIM, Daejeon (KR); Wan Kyu KIM, Daejeon (KR); Ji Hoon KWON, Daejeon (KR); Hyeong Il KIM, Daejeon (KR); Ho Jun KIM, Daejeon (KR); Ji Won PARK, Daejeon (KR); Jung Soo PARK, Daejeon (KR); Nam Moon KIM, Yongin-si (KR); Jeong Woo KIM, Yongin-si (KR); Do Jin AN, Yongin-si (KR)

(21) Appl. No.: 19/562,014

(22) Filed: Mar. 10, 2026

(30) Foreign Application Priority Data
Mar. 10, 2025 (KR) 10-2025-0030603

(51) Int. Cl. G01S 7/40; G01S 13/42; G01S 13/72; G01S 13/86; G01S 19/39

(52) U.S. Cl. CPC G01S 7/40; G01S 13/42; G01S 13/723; G01S 13/86; G01S 19/396

(57) ABSTRACT

According to example embodiments, a method of correcting an alignment status of a radar, which is performed by an electronic apparatus, includes identifying tracking information on a position of a satellite calculated based on a signal received from the satellite, identifying a tracking error for the satellite calculated by comparing the tracking information with position information of the satellite, acquiring an alignment compensation value for compensating for an alignment error of the radar based on the tracking error, and correcting the alignment status of the radar based on the alignment compensation value.

### TECHNICAL FIELD

The present disclosure relates to a method of correcting an alignment status of a radar and an electronic apparatus therefor. Specifically, the present disclosure relates to a method of correcting the alignment status of the radar by using a satellite and an electronic apparatus therefor.

### DESCRIPTION OF THE RELATED ART

To verify an alignment status that indicates the performance of a radar, a far-field testing is to be conducted. However, for a long-range radar, a space for performing the far-field test is limited considering the size, output power, or the like of the radar, and such testing is generally impossible within the Republic of Korea. Accordingly, a near-field test that verifies antenna performance in a near-field region is performed as an alternative. Nevertheless, since an error inevitably occurs in a far-field beam pattern predicted solely from the near-field data, this approach has a limitation in verifying the overall alignment status of the radar.

Meanwhile, the alignment of the radar may be performed by acquiring radar tracking data and extracting the tracking error thereof by using simulation equipment operated at a fixed position or a flying object such as an aircraft or a drone on which Global Positioning System (GPS) information is securable (e.g., data with accuracy equivalent to Differential Global Positioning System (DGPS)), based on the premise that accurate position information is known. However, in various environments in which the radar is deployed, a target object with high positional accuracy for the radar alignment is difficult to secure, and an issue such as excessive costs exists. Accordingly, developing and manufacturing test equipment for verifying and correcting the alignment status of the radar may be considered, but developing and producing general-purpose simulation equipment that reflects the diverse characteristics of radars is difficult. Thus, manufacturing separate test equipment for each radar is required. Furthermore, even if the test equipment for each radar is developed and produced, the installation position and operational environment of the test equipment may be limited.

For example, in the defense sector, an engagement radar is utilized to track a target and guide a missile toward the vicinity of the target through communication with the missile. In the case of such an engagement radar, more sophisticated alignment correction is required for ensuring and maintaining the tracking performance. Therefore, an alternative that allows more stably and precisely correcting the alignment status of various radars, including the engagement radar, while overcoming the limitation of the above-described conventional methods is required.

### DISCLOSURE OF THE INVENTION

### Technical Goals

An aspect provides a method for correcting an alignment status of a radar and an electronic apparatus therefor in order to solve the above-described difficulty.

The technical objectives to be achieved by the present embodiment are not limited to those described above, and other technical objectives may be inferred from the following example embodiments.

### Technical Solutions

According to an aspect, there is provided a method of correcting an alignment status of a radar, the method performed by an electronic apparatus and including identifying tracking information on a position of a satellite calculated based on a signal received from the satellite, identifying a tracking error for the satellite calculated by comparing the tracking information with position information of the satellite, acquiring an alignment compensation value for compensating for an alignment error of the radar based on the tracking error, and correcting the alignment status of the radar based on the alignment compensation value.

The signal may include a plurality of received pulses received as a plurality of transmitted pulses transmitted toward the satellite is reflected from the satellite.

A transmission interval between the plurality of transmitted pulses may be set so that each transmitted pulse included in the plurality of transmitted pulses and each received pulse included in the plurality of received pulses do not overlap each other.

The tracking information may include a distance from the radar to the satellite, and an azimuth angle and an elevation angle of the satellite identified based on the radar.

The position information of the satellite may include at least one of position prediction information generated based on Consolidated Prediction Format (CPF) information on the satellite, and position prediction information generated based on observation information on the satellite.

The tracking error may be used for acquiring the alignment compensation value when the tracking error is less than or equal to a predetermined threshold value.

The acquiring of the alignment compensation value may include acquiring the alignment compensation value through a calculation based on the tracking error and one or more previously acquired tracking errors.

The alignment compensation value includes at least one of a value for compensating for an alignment error in a yaw direction of the radar, a value for compensating for an alignment error in a pitch direction of the radar, and a value for compensating for an alignment error in a roll direction of the radar.

According to another aspect, there is also provided a non-transitory computer-readable recording medium in which a program for executing a method of correcting an alignment status of a radar on a computer is recorded, and the method of correcting an alignment status of a radar includes identifying tracking information on a position of a satellite calculated based on a signal received from the satellite, identifying a tracking error for the satellite calculated by comparing the tracking information with position information of the satellite, acquiring an alignment compensation value for compensating for an alignment error of the radar based on the tracking error, and correcting the alignment status of the radar based on the alignment compensation value.

According to still another aspect, there is also provided an electronic apparatus for correcting an alignment status of a radar, the electronic apparatus including a processor, and one or more memories configured to store one or more instructions, and when executed, the one or more instructions are configured to control the processor to identify tracking information on a position of a satellite calculated based on a signal received from the satellite, identify a tracking error for the satellite calculated by comparing the tracking information with position information of the satellite, acquire an alignment compensation value for compensating for an alignment error of the radar based on the tracking error, and correct the alignment status of the radar based on the alignment compensation value.

### Effects

According to example embodiments, it is possible to inspect performance and an alignment status of a radar with a low cost and without a limitation on a space and furthermore perform and correct alignment of the radar.

According to example embodiments, it is possible to verify whether any abnormality in the performance of the radar exists in various operational environments such as the land or the sea and minimize an error in a range obtained by and directional orientation of the radar.

The effects of the present disclosure are not limited to those mentioned above, and other effects not mentioned will be clearly understood by those skilled in the art from the description of the claims.

### BRIEF DESCRIPTION OF THE DRAWINGS

FIG. 1 illustrates an electronic apparatus according to an example embodiment.

FIG. 2 is a flowchart illustrating a method of correcting an alignment status of a radar according to an example embodiment.

FIG. 3 illustrates signal transmission and reception by an electronic apparatus for satellite tracking according to an example embodiment.

FIG. 4 illustrates a process of operating a waveform of a signal for satellite tracking according to an example embodiment.

FIG. 5 is a block diagram illustrating an electronic apparatus for correcting an alignment status of a radar according to an example embodiment.

FIG. 6 is a block diagram illustrating a radar according to an example embodiment.

### DETAILED DESCRIPTION FOR CARRYING OUT THE INVENTION

Hereinafter, example embodiments of the present disclosure will be described in detail with reference to the accompanying drawings.

Terms used in the example embodiments have been selected from general terms that are currently widely used in consideration of functions in the present disclosure. However, these terms may vary depending on the intentions of those skilled in the art, judicial precedents, the emergence of new technologies, or the like. In addition, there are terms arbitrarily selected by the applicant in some cases, and in such cases, the meanings thereof will be described in detail in the corresponding description sections. Therefore, the terms used in the present disclosure should be defined based on the meanings of the terms and the overall content of the present disclosure, rather than simply names of the terms.

Throughout the specification, when a part is described to “include” an element, this means that the part may further include another element rather than excluding the other element, unless particularly described otherwise. In addition, a term such as “part” or “module” described in the specification refers to a unit that processes at least one function or operation, which may be implemented as hardware or software, or as a combination of hardware and software.

The expression “at least one of a, b, and c” described throughout the specification may encompass ‘a alone’, ‘b alone’, ‘c alone’, ‘a and b’, ‘a and c’, ‘b and c’, or ‘all of a, b, and c’.

Hereinafter, the example embodiments of the present disclosure will be described in detail with reference to the accompanying drawings so that those skilled in the art to which the present disclosure belongs may easily carry out the example embodiments. However, the present disclosure may be implemented in various different forms and is not limited to the example embodiments described herein.

Hereinafter, the example embodiments of the present disclosure for specifically performing a method of correcting an alignment status of a radar will be described in detail with reference to the drawings.

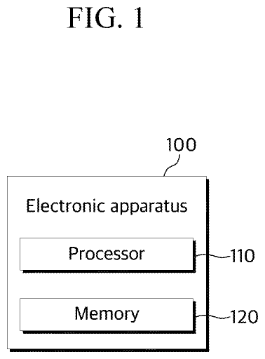

FIG. 1 illustrates an electronic apparatus according to an example embodiment.

Referring to FIG. 1, an electronic apparatus 100 may include a processor 110 and a memory 120 according to an example embodiment. With respect to the electronic apparatus 100 illustrated in FIG. 1, only elements associated with the present example embodiment are illustrated. Therefore, it will be understood by those skilled in the art associated with the present example embodiment that other general-purpose elements may be further included in addition to the elements illustrated in FIG. 1.

The electronic apparatus 100 may be an apparatus for performing correction of an alignment status of a radar by using a satellite, and the processor 110 may control overall operations of the electronic apparatus 100 and process data and signals. The processor 110 may be configured as at least one hardware unit. In addition, the processor 110 may be operated by one or more software modules generated by executing program code stored in the memory 120. Since the processor 110 may include a memory, the processor 110 may control overall operations of the electronic apparatus 100 and process data and signals by executing program code stored in the memory.

The processor 110 may be implemented as a computer or a similar device depending on hardware, software, or a combination thereof. In terms of hardware, the processor 110 may be implemented in a form of an electronic circuit that performs a control function by processing an electrical signal. In terms of software, the processor 110 may be implemented in a form of a program for driving the processor 110 as the hardware. Meanwhile, unless described otherwise in the following description, an operation of the electronic apparatus may be interpreted as being performed by control by the processor 110. That is, when modules implemented in a system for correcting the alignment status of the radar are executed, the modules may be interpreted as controlling the processor 110 to perform the following operations of the electronic apparatus 100.

The memory 120 may store a variety of information. The memory 120 may store data temporarily or semi-permanently. For example, data on an operating system (OS) for driving the electronic apparatus 100 may be stored in the memory 120 of the electronic apparatus 100. An example of the memory 120 may include a hard disk drive (HDD), a solid state drive (SSD), a flash memory, a read-only memory (ROM), a random access memory (RAM), or the like. Such a memory 120 may be provided as a built-in type or a detachable type.

The electronic apparatus 100 may further include a communication device including one or more transceivers, an input part, and an output part. The communication device is a device for performing wired or wireless communication and may communicate with an external electronic apparatus, and the external electronic apparatus may be a terminal or a server. The electronic apparatus 100 may further acquire relevant information required for correcting the alignment status of the radar from the external electronic apparatus through the communication device. A communication technology used by the communication device may include Global System for Mobile communication (GSM), code-division multi access (CDMA), long term evolution (LTE), 5G, a wireless local area network (WLAN), Wireless-Fidelity (Wi-Fi), Bluetooth, radio frequency identification (RFID), Infrared Data Association (IrDA), ZigBee, near field communication (NFC), or the like.

Meanwhile, the input part may be, for example, a traditional form of a keypad or keyboard, a mouse, a microphone for receiving a voice signal, a camera, or a sensor, or other various types of input devices for detecting or receiving various forms of user input. The output part may be, for example, a display for outputting an image, a speaker for outputting sound, a haptic device for generating vibration, or other various types of output devices.

In summary, various example embodiments may be implemented through various devices. For example, various example embodiments may be implemented by hardware, firmware, software, or a combination thereof.

In a case of implementation by hardware, a method according to various example embodiments may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In a case of implementation by firmware or software, the method according to various example embodiments may be implemented in a form of a module, a procedure, or a function that performs the functions or operations described above. For example, software code may be stored in a memory and driven by a processor. The memory may be located inside or outside the processor and may exchange data with the processor by various known devices.

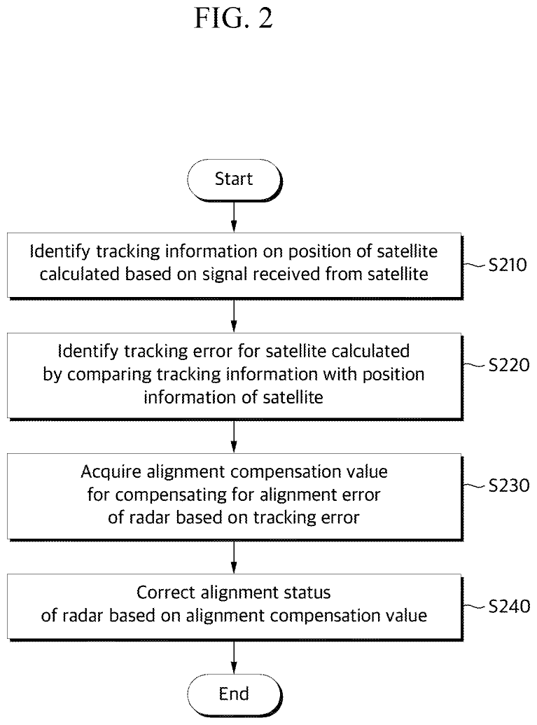

FIG. 2 is a flowchart illustrating a method of correcting an alignment status of a radar according to an example embodiment.

According to an example embodiment, the electronic apparatus 100 may identify tracking information on a position of a satellite calculated based on a signal received from the satellite in operation S210 and identify a tracking error for the satellite calculated by comparing the tracking information with position information of the satellite in operation S220. Subsequently, the electronic apparatus 100 may acquire an alignment compensation value for compensating for an alignment error of the radar based on the tracking error in operation S230 and correct the alignment status of the radar based on the alignment compensation value in operation S240.

That is, the electronic apparatus 100 may check and correct the alignment status of the radar by using a satellite. The radar which is subject to such checking and correction of the alignment status may include various types of radars regardless of whether the radars are developed for purpose of satellite tracking and may be, for example, a long-range radar.

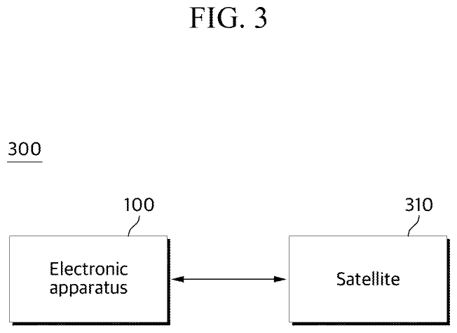

FIG. 3 illustrates signal transmission and reception by an electronic apparatus for satellite tracking according to an example embodiment.

According to an example embodiment, the electronic apparatus 100 may control a radar for satellite tracking. Specifically, the electronic apparatus 100 may provide position information of a satellite 310 acquired in advance to the radar in order to minimize radar resource allocation and increase a detection range. The radar may be controlled to track the satellite 310 by transmitting a detection beam to an expected position of the satellite 310 based on such position information.

In this case, the satellite 310 may include various satellites on which position information is acquirable. The position information of the satellite 310 may include, for example, at least one of position prediction information generated based on Consolidated Prediction Format (CPF) information on a satellite and position prediction information generated based on observation information on the satellite. The CPF information may refer to satellite prediction information used by the International Laser Ranging Service (ILRS), which provides more precise position prediction information on a satellite among artificial satellite orbit determination systems, and has very high precision. Meanwhile, the position prediction information generated based on the observation information on the satellite may be, for example, two-line element (TLE) information including information on a satellite orbit measured and updated by the North American Aerospace Defense Command (NORAD) for a satellite orbiting the Earth. Such TLE information may have accuracy varying depending on a type and shape of a trajectory, a sensor used for satellite measurement, a space environment, or the like and thus may be lower than that of the CPF information. However, unlike the CPF information which is relatively difficult to acquire in real time, the TLE information may be acquired in real time. The position information of the satellite 310 which serves as a basis for correcting an alignment status of the radar is not limited to the above-described example and may include a variety of position information according to an example embodiment.

Meanwhile, the detection beam (i.e., a signal) transmitted to the satellite 310 by the radar may include a plurality of transmitted pulses repeated at a plurality of predetermined periods. Accordingly, a signal received from the satellite to the radar may include, for example, a plurality of received pulses received as the plurality of transmitted pulses transmitted toward the satellite is reflected from the satellite.

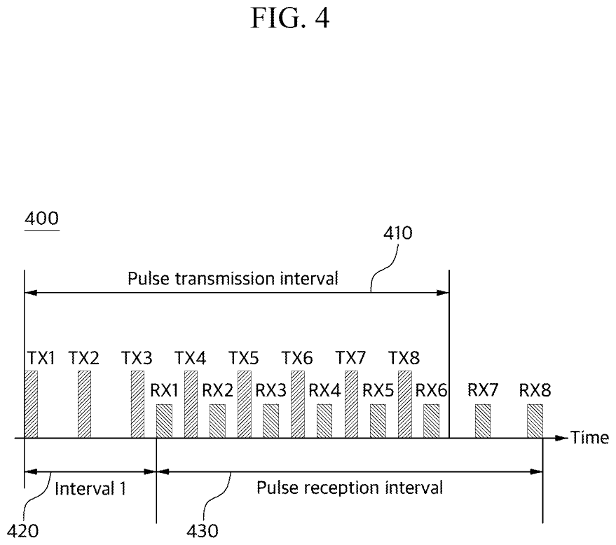

FIG. 4 illustrates a process 400 of operating a waveform of a signal for satellite tracking according to an example embodiment.

Referring to FIG. 4, a radar may transmit a plurality of transmitted pulses, such as TX1 and TX2, toward a satellite during a pulse transmission interval 410, and accordingly, may receive a plurality of received pulses, such as RX1 and RX2, from the satellite during a pulse reception interval 430. In an example, the satellite which is tracked may be positioned at a point R kilometers (km) away from the radar, and accordingly, a first received pulse RX1 received from the satellite may arrive τ milliseconds (ms) after a time point at which a first transmitted pulse TX1 is transmitted. Accordingly, the electronic apparatus 100 may sequentially transmit the plurality of transmitted pulses through the radar and then process the received pulses from τ ms after the time point of transmitting the first transmitted pulse TX1. At this point, a transmission interval (namely, a pulse repetition interval (PRI)) between the plurality of transmitted pulses may be set so that each transmitted pulse included in the plurality of continuously transmitted pulses and each received pulse included in the plurality of received pulses received from τ ms after the time point of transmitting the first transmitted pulse TX1 do not overlap each other.

Meanwhile, since a distance between the satellite and the radar is long, a fill pulse region in which a received pulse is absent for a predetermined time after the first transmitted pulse TX1 is transmitted may be present, as shown in an interval 1 represented by reference numeral 420. Accordingly, in order to secure an effective signal-to-noise ratio for satellite detection, the radar may be controlled to track the satellite in a scheme of transmitting a plurality of pulses and then processing a reception signal by opening a reception signal gate after a delay time corresponding to the fill pulse region elapses.

When the radar is controlled according to such a scheme, whether an abnormality in tracking accuracy of the radar is present may be directly or indirectly identified by comparing information on the satellite tracked through the radar with position information of the satellite as described above. Furthermore, whether an abnormality in a transmission output of the radar is present also may be identified based on whether the radar may output a transmission signal, whether strength of a radio wave received from the satellite is constant, or the like.

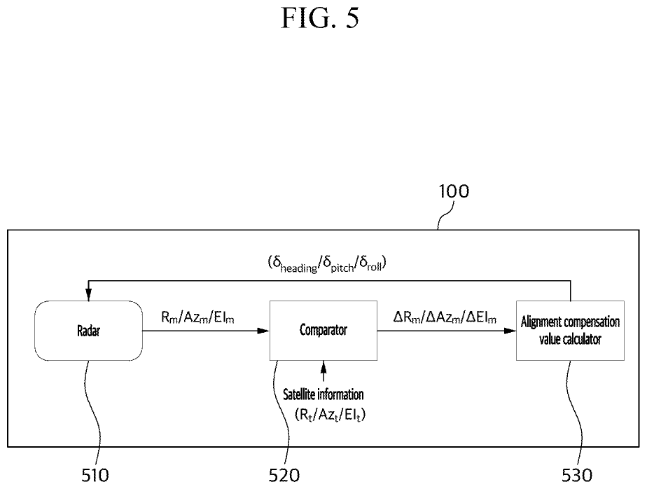

FIG. 5 is a block diagram illustrating an electronic apparatus for correcting an alignment status of a radar according to an example embodiment.

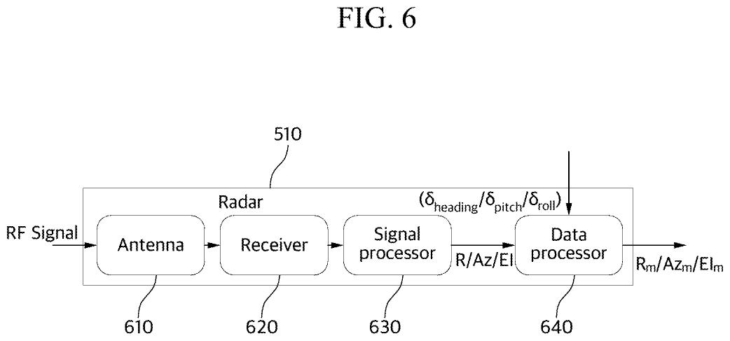

According to an example embodiment, the electronic apparatus 100 may include a radar 510, a comparator 520, and an alignment compensation value calculator 530. The radar 510 may calculate tracking information on a position of a satellite based on a signal received from the satellite. Here, the tracking information may include a distance Rm from the radar to the satellite and an azimuth angle Azm and an elevation angle Elm of the satellite identified based on the radar. A more detailed example embodiment of an operation of the radar will be described in detail below with reference to FIG. 6.

The electronic apparatus 100 may compare, through the comparator 520, tracking information Rm, Azm, and Elm on the satellite acquired and identified from the radar with position information of the satellite (referred to as ‘satellite information’ in FIG. 5) including CPF information having high predictability or position prediction information generated based on satellite observation (hereinafter referred to as ‘actual satellite information’ for convenience). Specifically, the satellite information compared with the tracking information may include a distance Rt from the radar to the satellite and an azimuth angle Azt and an elevation angle Elt of the satellite identified based on the radar. The comparator 520 may calculate a tracking error for the satellite by comparing the tracking information with the satellite information. Here, the tracking error may include a tracking error ΔRm associated with a distance, a tracking error ΔAzm associated with an azimuth angle, and a tracking error AElm associated with an elevation angle.

Specifically, the comparator 520 performs a function of calculating an error between actual satellite information Rt, Azt, and Elt on the same satellite (or position prediction information Re, Aze, and Ele on the satellite having high predictability) and the tracking information Rm, Azm, and Elm on the satellite of the radar. The position prediction information on the satellite may be obtained, for example, by generating, based on the CPF information, a simulated trajectory with a Coordinated Universal Time (UTC) time as a reference. At this point, an error of the simulated trajectory may be within millimeters. Meanwhile, the comparator 520 may calculate the tracking error except when the radar loses a target being tracked (for example, when the satellite is not detectable any longer, or when the signal is interrupted). In addition, the tracking error calculated by the comparator 520 may be used for acquiring an alignment compensation value when the tracking error is less than or equal to a predetermined threshold value. The predetermined threshold value may be, for example, an average value of previously calculated tracking errors. Although a tracking error greater than the average value of the previously calculated tracking errors may occur due to a detection beam radiation position of the radar and a radar cross section (RCS) fluctuation, such a value has considerably low reliability. If such a case occurs frequently, performance of correcting the alignment status of the radar may become unstable. Therefore, the electronic apparatus 100 may input the tracking error calculated by the comparator 520 to the alignment compensation value calculator 530 when the tracking error is less than or equal to the average value of the previously calculated tracking errors.

The alignment compensation value calculator 530 may receive the tracking errors ΔRm, ΔAzm, and ΔElm calculated by the comparator 520 and output an alignment compensation value for compensating for an alignment error of the radar 510. The electronic apparatus 100 may acquire the alignment compensation value through such an alignment compensation value calculator 530. The alignment compensation value which is output from the alignment compensation value calculator 530 may be a complex alignment compensation value. Here, unlike a concept of a correction value (bias value) measured by using a conventional beacon, aircraft, or the like and reflected in the radar, the complex alignment compensation value may refer to a compensation value for optimizing the alignment status of the radar in complex consideration of correction values according to various error factors such as a mechanical installation error of the radar 510 acquirable by using a satellite and other electronic and environmental factors. In addition, the alignment compensation value may include, for example, at least one of a value δheading for compensating for an alignment error in a yaw direction of the radar, a value δpitch for compensating for an alignment error in a pitch direction of the radar, and a value δroll for compensating for an alignment error in a roll direction of the radar. That is, the alignment compensation value may be correction values for three rotation angles for compensating for an alignment error of the radar.

The electronic apparatus 100 may correct an alignment status of the radar 510 by applying, to the radar 510, the alignment compensation values δheading, δpitch, and δroll acquired through the alignment compensation value calculator 530. Here, application of the alignment compensation value may be performed according to at least one of a real-time compensation value application technique that uses the position information of the satellite acquired in real time and a post-processing compensation value application technique that uses the position information of the satellite acquired after termination of satellite tracking. Specifically, in an example, the position information of the satellite compared with the tracking information for calculating the tracking error may be the actual satellite information acquired in real time. In this case, the electronic apparatus 100 may acquire alignment compensation values corresponding to sequentially calculated tracking errors according to the real-time compensation value application technique and correct the alignment status of the radar 510 in real time according to each of the acquired alignment compensation values. In another example, when the position information of the satellite compared with the tracking information for calculating the tracking error is the CPF information which is acquired after the termination of the satellite tracking (namely, a time point at which all signals received from the satellite are processed), the electronic apparatus 100 may acquire the alignment compensation value through a calculation based on the tracking error and one or more previously acquired tracking errors according to the post-processing compensation value application technique and correct the alignment status of the radar 510 by applying the acquired alignment compensation value. That is, the alignment compensation value calculator 530 may calculate one optimal alignment compensation value through a calculation based on tracking errors accumulated during the satellite tracking. The electronic apparatus 100 may correct the alignment status by applying the optimal alignment compensation value to the radar 510 after the termination of the satellite tracking.

FIG. 6 is a block diagram illustrating a radar according to an example embodiment.

Referring to FIG. 6, the radar 510 may include an antenna 610, a receiver 620, a signal processor 630, and a data processor 640. Specifically, the radar 510 may acquire a signal (e.g., a radio frequency (RF) signal) reflected from a satellite and received through the antenna 610. The signal acquired as such may be identified as tracking information such as a distance between the radar 510 and the satellite and an azimuth angle and an elevation angle of the satellite identified based on the radar, through the data processor 640 via the receiver 620 and the signal processor 630. More specifically, the antenna 610 may perform a function of converting an electrical signal into electromagnetic wave energy, radiating the electromagnetic wave energy into a space to transmit a detection beam toward the satellite, and then focusing electromagnetic wave energy reflected from the satellite to convert the focused energy into an electrical signal (namely, an RF signal). Subsequently, the receiver 620 may amplify a reflected signal, which is a high-frequency electrical signal acquired from the antenna 610 and has a weak intensity, down-convert and demodulate a frequency thereof, and transmit the down-converted and demodulated signal to the signal processor 630. The signal processor 630 may perform a function of finding information on the satellite by classifying a complex radar signal acquired from the receiver 620 into a signal associated with the satellite and a signal not associated with the satellite.

Meanwhile, the data processor 640 may calculate data indicating tracking performance of the radar 510 for the satellite based on the tracking information on the satellite calculated by the signal processor 630 and may operate, by controlling all parameters of a radar system, in order to acquire optimal radar performance. The tracking information on the satellite calculated by the signal processor 630 may be values R, Az, and El estimated by the radar 510 with respect to a position of the satellite and have a tracking error due to internal and external interference. To resolve this, the radar 510 may calculate more accurate tracking information Rm, Azm, and Elm by applying the alignment compensation values δheading, δpitch, and δroll in the data processor 640. Here, an alignment compensation value may be a value acquired through the alignment compensation value calculator 530 as described above. As such, the electronic apparatus 100 may repeatedly perform a process of acquiring the alignment compensation value based on the tracking error for the satellite to correct an alignment status of the radar, obtaining a new tracking error based on the corrected alignment status, and acquiring a new alignment compensation value based on the new tracking error.

The electronic apparatus according to the above-described example embodiments may include a processor, a memory for storing and executing program data, a permanent storage such as a disk drive, a communication port for communicating with an external device, and a user interface device such as a touch panel, a key, and a button, and the like. Methods implemented with a software module or an algorithm may be stored in a computer-readable recording medium as computer-readable code or program instructions executable on the processor. An example of the computer-readable recording medium includes a magnetic storage medium (e.g., a read-only memory (ROM), a random-access memory (RAM), a floppy disk, a hard disk, or the like.) and an optical reading medium (e.g., a compact disc read-only memory (CD-ROM) or a digital versatile disc (DVD)). The computer-readable recording medium may be distributed over network-coupled computer systems, so that the computer-readable code is stored and executed in a distributed manner. The medium may be readable by a computer, stored in a memory, and executed in a processor.

The present example embodiment may be represented by functional block configurations and various processing operations. Such functional blocks may be implemented by various numbers of hardware and/or software configurations that execute predetermined functions. For example, the example embodiments may employ direct circuit configurations such as a memory, processing, logic, and a look-up table, which may execute various functions by control by one or more microprocessors or other control devices. Similarly to that elements may be executed with software programming or software elements, the present example embodiment may be implemented in a programming or scripting language such as C, C++, Java, or assembler language, including various algorithms implemented by a combination of data structures, processes, routines, or other programming configurations. Functional aspects may be implemented by an algorithm executed on one or more processors. In addition, the present example embodiment may employ conventional technologies for electronic environment setting, signal processing, data processing, and/or the like. Terms such as “mechanism,” “element,” “means,” and “configuration” may be used broadly and are not limited to mechanical and physical elements. The terms may include meanings of a series of routines of software in association with a processor or the like.

The above-described example embodiments are merely examples, and other example embodiments may be implemented within the scope of the claims described below.

1. A method of correcting an alignment status of a radar, the method performed by an electronic apparatus and comprising:
identifying tracking information on a position of a satellite calculated based on a signal received from the satellite;
identifying a tracking error for the satellite calculated by comparing the tracking information with position information of the satellite;
acquiring an alignment compensation value for compensating for an alignment error of the radar based on the tracking error; and
correcting the alignment status of the radar by applying the alignment compensation value to the radar,
wherein the acquiring of the alignment compensation value comprises acquiring the alignment compensation value through a calculation based on the tracking error and one or more previously acquired tracking errors,
wherein the alignment compensation value includes at least one of:
a value for compensating for an alignment error in a yaw direction of the radar;
a value for compensating for an alignment error in a pitch direction of the radar; and
a value for compensating for an alignment error in a roll direction of the radar,
wherein a new tracking information for the satellite, having a minimized tracking error, is obtained based on the optimized alignment status of the radar according to the correction,
wherein the signal includes a plurality of received pulses received as a plurality of transmitted pulses transmitted toward the satellite is reflected from the satellite,
wherein a transmission interval between the plurality of transmitted pulses is set so that each transmitted pulse included in the plurality of transmitted pulses and each received pulse included in the plurality of received pulses do not overlap each other,
wherein the signal is received through a reception signal gate of the radar,
wherein the reception signal gate is controlled to receive and process the signal at a time point after a predetermined time has elapsed from a time point at which transmission of the plurality of transmitted pulses starts,
wherein the predetermined time corresponds to a time taken from the time point at which transmission of the plurality of transmitted pulses starts until the plurality of received pulses are received,
wherein the tracking information includes:
a distance from the radar to the satellite; and
an azimuth angle and an elevation angle of the satellite identified based on the radar,
wherein the tracking error comprises a tracking error associated with the distance, a tracking error associated with the azimuth angle, and a tracking error associated with the elevation angle,
wherein the tracking error is used for acquiring the alignment compensation value when the tracking error is less than or equal to a predetermined threshold value, and
wherein the predetermined threshold value is an average value of the one or more previously acquired tracking errors.

2. (canceled)

3. (canceled)

4. (canceled)

5. The method of claim 1, wherein the position information of the satellite includes at least one of:
position prediction information generated based on Consolidated Prediction Format (CPF) information on the satellite; and
position prediction information generated based on observation information on the satellite.

6. (canceled)

7. (canceled)

8. (canceled)

9. A non-transitory computer-readable recording medium in which a program for executing a method of correcting an alignment status of a radar on a computer is recorded,
wherein the method of correcting an alignment status of a radar comprises:
identifying tracking information on a position of a satellite calculated based on a signal received from the satellite;
identifying a tracking error for the satellite calculated by comparing the tracking information with position information of the satellite;
acquiring an alignment compensation value for compensating for an alignment error of the radar based on the tracking error; and
correcting the alignment status of the radar by applying the alignment compensation value to the radar,
wherein the acquiring of the alignment compensation value comprises acquiring the alignment compensation value through a calculation based on the tracking error and one or more previously acquired tracking errors,
wherein the alignment compensation value includes at least one of:
a value for compensating for an alignment error in a yaw direction of the radar;
a value for compensating for an alignment error in a pitch direction of the radar; and
a value for compensating for an alignment error in a roll direction of the radar,
wherein a new tracking information for the satellite, having a minimized tracking error, is obtained based on the optimized alignment status of the radar according to the correction,
wherein the signal includes a plurality of received pulses received as a plurality of transmitted pulses transmitted toward the satellite is reflected from the satellite,
wherein a transmission interval between the plurality of transmitted pulses is set so that each transmitted pulse included in the plurality of transmitted pulses and each received pulse included in the plurality of received pulses do not overlap each other,
wherein the signal is received through a reception signal gate of the radar,
wherein the reception signal gate is controlled to receive and process the signal at a time point after a predetermined time has elapsed from a time point at which transmission of the plurality of transmitted pulses starts,
wherein the predetermined time corresponds to a time taken from the time point at which transmission of the plurality of transmitted pulses starts until the plurality of received pulses are received,
wherein the tracking information includes:
a distance from the radar to the satellite; and
an azimuth angle and an elevation angle of the satellite identified based on the radar,
wherein the tracking error comprises a tracking error associated with the distance, a tracking error associated with the azimuth angle, and a tracking error associated with the elevation angle,
wherein the tracking error is used for acquiring the alignment compensation value when the tracking error is less than or equal to a predetermined threshold value, and
wherein the predetermined threshold value is an average value of the one or more previously acquired tracking errors.

10. An electronic apparatus for correcting an alignment status of a radar, the electronic apparatus comprising:
a processor; and
one or more memories configured to store one or more instructions,
wherein when executed, the one or more instructions are configured to control the processor to:
identify tracking information on a position of a satellite calculated based on a signal received from the satellite;
identify a tracking error for the satellite calculated by comparing the tracking information with position information of the satellite;
acquire an alignment compensation value for compensating for an alignment error of the radar based on the tracking error; and
correct the alignment status of the radar by applying the alignment compensation value to the radar,
wherein the acquiring of the alignment compensation value comprises acquiring the alignment compensation value through a calculation based on the tracking error and one or more previously acquired tracking errors,
wherein the alignment compensation value includes at least one of:
a value for compensating for an alignment error in a yaw direction of the radar;
a value for compensating for an alignment error in a pitch direction of the radar; and
a value for compensating for an alignment error in a roll direction of the radar,
wherein a new tracking information for the satellite, having a minimized tracking error, is obtained based on the optimized alignment status of the radar according to the correction,
wherein the signal includes a plurality of received pulses received as a plurality of transmitted pulses transmitted toward the satellite is reflected from the satellite,
wherein a transmission interval between the plurality of transmitted pulses is set so that each transmitted pulse included in the plurality of transmitted pulses and each received pulse included in the plurality of received pulses do not overlap each other,
wherein the signal is received through a reception signal gate of the radar,
wherein the reception signal gate is controlled to receive and process the signal at a time point after a predetermined time has elapsed from a time point at which transmission of the plurality of transmitted pulses starts,
wherein the predetermined time corresponds to a time taken from the time point at which transmission of the plurality of transmitted pulses starts until the plurality of received pulses are received,
wherein the tracking information includes:
a distance from the radar to the satellite; and
an azimuth angle and an elevation angle of the satellite identified based on the radar,
wherein the tracking error comprises a tracking error associated with the distance, a tracking error associated with the azimuth angle, and a tracking error associated with the elevation angle,
wherein the tracking error is used for acquiring the alignment compensation value when the tracking error is less than or equal to a predetermined threshold value, and
wherein the predetermined threshold value is an average value of the one or more previously acquired tracking errors.
